(19) United States
(12) Patent Application Publication
(10) Pub. No.: US 2007/0200976 A1
(43) Pub. Date: Aug. 30, 2007

(54) Elliptically Polarizing Plate, Method Of Producing The Same, And Image Display Apparatus Employing The Elliptically Polarizing Plate

(75) Inventors: Ikuo Kawamoto, Osaka (JP); Seiji Umemoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 10/582,582

(22) PCT Filed: Nov. 7, 2005
(86) PCT No.: PCT/JP05/20347

§ 371 Date: Mar. 20, 2007

(30) Foreign Application Priority Data
Dec. 14, 2004 (JP) 2004-361047

(51) Int. Cl. G02F 1/1335

(52) U.S. Cl. 349/96

(57) ABSTRACT

To provide: a very thin elliptically polarizing plate having broadband and wide viewing angle; a simple method of producing the same; and an image display apparatus employing the elliptically polarizing plate. The elliptically polarizing plate of the present invention includes a polarizer, a protective layer formed on one side of the polarizer, a first birefringent layer serving as a λ/2 plate, and a second birefringent layer serving as a λ/4 plate. In the elliptically polarizing plate, the first birefringent layer and the second birefringent layer are each formed by using a liquid crystal material. Preferably, the first birefringent layer has a thickness of 0.5 to 5 μm and the second birefringent layer has a thickness of 0.3 to 3 μm.

### TECHNICAL FIELD

The present invention relates to an elliptically polarizing plate, to a method of producing the same, and to an image display apparatus employing the elliptically polarizing plate. More specifically, the present invention relates to a very thin elliptically polarizing plate having broadband and wide viewing angle, to a simple method of producing the same, and to an image display apparatus employing the elliptically polarizing plate.

### BACKGROUND ART

Various optical films each having a polarizing film and a retardation plate in combination are generally used for various image display apparatuses such as a liquid crystal display apparatus and an electroluminescence (EL) display, to thereby obtain optical compensation.

In general, a circularly polarizing plate which is one type of the optical films can be produced by combining a polarizing film and a λ/4 plate. However, the λ/4 plate has characteristics providing larger retardation values with shorter wavelengths, so-called “positive wavelength dispersion characteristics”, and the λ/4 plate generally has high positive wavelength dispersion characteristics. Thus, the λ/4 plate has a problem in that it cannot exhibit desired optical characteristics (such as functions of the λ/4 plate) over a wide wavelength range. In order to avoid the problem, there has been recently proposed a retardation plate having wavelength dispersion characteristics providing larger retardation values with longer wavelengths, so-called “reverse dispersion characteristics” such as a norbornene-based film or a modified polycarbonate-based film. However, such a film has problems in cost.

At present, a λ/4 plate having positive wavelength dispersion characteristics is combined with, for example, a retardation plate providing larger retardation values with longer wavelengths or a λ/2 plate, to thereby correct the wavelength dispersion characteristics of the λ/4 plate (see JP 3174367 B, for example)

In a case where a polarizing film, a λ/4 plate, and a λ/2 plate are combined as described above, angles of respective optical axes, that is, angles between an absorption axis of the polarizing film and slow axes of the respective retardation plates must be adjusted. However, the optical axes of the polarizing film and the retardation plates each formed of a stretched film generally vary depending on stretching directions. The respective films must be cut out in accordance with directions of the respective optical axes and laminated, to thereby laminate the films such that the absorption axis and the slow axes are at desired angles. To be specific, an absorption axis of a polarizing film is generally in parallel with its stretching direction, and a slow axis of a retardation plate is also in parallel with its stretching direction. Thus, for lamination of the polarizing film and the retardation plate at an angle between the absorption axis and the slow axis of 45°, for example, one of the films must be cut out in a direction of 45° with respect to a longitudinal direction (stretching direction) of the film. In the case where a film is cut out and then attached as described above, angles between optical axes may vary by cut-out film, for example. The variation may result in problems of variation in quality by product and production requiring high cost and long time. Further problems include increased waste by cutting out of the films, and difficulties in production of large films.

As a countermeasure to the problems, there is proposed a method of adjusting a stretching direction by stretching a polarizing film or a retardation plate in an oblique direction or the like (see JP 2003-195037 A, for example). However, the method has a problem in that the adjustment involves difficulties.

Further, a demand for reduction in thickness of an image display apparatus has increased recently. With the increasing demand, a demand for reduction in thickness of an optical film such as a circularly polarizing plate has also increased.

### DISCLOSURE OF THE INVENTION

### Problems to be Solved by the Invention

The present invention has been made in view of solving the conventional problems described above, and an object of the present invention is therefore to provide a very thin elliptically polarizing plate having broadband and wide viewing angle, to a simple method of producing the same, and to an image display apparatus employing the elliptically polarizing plate.

### MEANS FOR SOLVING THE PROBLEMS

The inventors of the present invention have conducted intensive studies on properties of the elliptical polarizing plate, and have found that the above-mentioned object can be attained by applying a liquid crystal material to a specific substrate, transferring the formed birefringent layer, and forming a very thin λ/4 plate having excellent optical properties. Thus, the inventors have completed the present invention.

The elliptically polarizing plate of the present invention includes a polarizer, a protective layer formed on one side of the polarizer, a first birefringent layer serving as a λ/2 plate, and a second birefringent layer serving as a λ/4 plate in the order given. In the elliptically polarizing plate, the first birefringent layer and the second birefringent layer are each formed by using a liquid crystal material.

According to a preferred embodiment, the first birefringent layer has a thickness of 0.5 to 5 μm. Further, the second birefringent layer has a thickness of 0.3 to 3 μm.

According to a preferred embodiment, a slow axis of the first birefringent layer is defined at one angle of +8° to +38° and −8° to −38° with respect to an absorption axis of the polarizer. According to a preferred embodiment, the absorption axis of the polarizer and a slow axis of the second birefringent layer are substantially perpendicular to each other.

Another aspect of the present invention provides a method of producing an elliptically polarizing plate. The method includes the steps of: subjecting a surface of a transparent protective film (T) to alignment treatment; forming a first birefringent layer on the surface of the transparent protective film (T) subjected to the alignment treatment; laminating a polarizer on a surface of the transparent protective film (T); and laminating a second birefringent layer on the surface of the first birefringent layer. In the method, the polarizer and the first birefringent layer are arranged on opposite sides of the transparent protective film (T).

According to a preferred embodiment, the transparent protective film (T), the first birefringent layer, the polarizer, and the second birefringent layer are continuous films, and long sides of the transparent protective film (T), the first birefringent layer, the polarizer, and the second birefringent layer are attached together for lamination. According to a preferred embodiment, the step of forming a first birefringent layer includes the steps of: applying an application liquid containing a liquid crystal material; and aligning the applied liquid crystal material through treatment at a temperature at which the liquid crystal material exhibits a liquid crystal phase. According to another preferred embodiment, the liquid crystal material includes at least one of a polymerizable monomer and a crosslinking monomer, and the step of aligning the liquid crystal material further includes the step of performing at least one of polymerization treatment and crosslinking treatment. According to still another preferred embodiment, at least one of the polymerization treatment and the crosslinking treatment is performed by one of heating and photoirradiation.

According to a preferred embodiment, the step of laminating a second birefringent layer includes the steps of: applying an application liquid containing a liquid crystal material to a substrate; forming a second birefringent layer on the substrate by subjecting the applied liquid crystal material to treatment at a temperature at which the liquid crystal material exhibits a liquid crystal phase; and transferring the second birefringent layer formed on the substrate to the surface of the first birefringent layer. According to a preferred embodiment, the substrate is a continuous film having an alignment axis in its width direction. According to another preferred embodiment, a variation in alignment axis of the substrate is ±1° or less with respect to an average direction of the alignment axes. According to still another preferred embodiment, the substrate is a polyethylene terephthalate film obtained through stretching treatment and recrystallization treatment. According to a preferred embodiment, the substrate is used for the step of applying an application liquid without being subjected to alignment treatment on its surface.

Another aspect of the present invention provides an image display apparatus. This image display apparatus includes the above-mentioned elliptically polarizing plate.

### EFFECT OF THE INVENTION

As described above, according to the present invention, the first birefringent layer and the second birefringent layer are each formed of a liquid crystal material, to thereby remarkably increase a difference between nx and ny compared with that in the case where the first birefringent layer and the second birefringent layer are each formed of a stretched polymer film. As a result, a thickness of the first birefringent layer for providing a desired in-plane retardation for the first birefringent layer to serve as a λ/2 plate may be reduced remarkably as compared to the conventional one, and a thickness of the second birefringent layer for providing a desired in-plane retardation for the second birefringent layer to serve as a λ/4 plate may be reduced remarkably as compared to the conventional one. Thus, the elliptically polarizing plate of the present invention may have a remarkably reduced thickness compared with that of a conventional elliptically polarizing plate, and may greatly contribute to reduction in thickness of an image display apparatus. Further, in the elliptically polarizing plate of the present invention, alignment of the liquid crystal material of each of the first birefringent layer and the second birefringent layer is fixed through polymerization or crosslinking, and thus the elliptically polarizing plate of the present invention has remarkably excellent heat resistance compared with that of the conventional elliptically polarizing plate. As a result, the elliptically polarizing plate of the present invention has a particular effect in that its optical properties do not degrade even in a high temperature environment (such as in vehicle use).

### BRIEF DESCRIPTION OF THE DRAWINGS

In the accompanying drawings:

FIG. 1 is a schematic sectional view of an elliptically polarizing plate according to a preferred embodiment of the present invention;

FIG. 2 is an exploded perspective view of an elliptically polarizing plate according to the preferred embodiment of the present invention;

FIG. 3 is a perspective view showing a step in the example of a method of producing an elliptically polarizing plate according to the present invention;

FIGS. 4A and 4B are perspective views showing another step in the example of a method of producing an elliptically polarizing plate according to the present invention;

FIG. 5 is a schematic view showing still another step in the example of a method of producing an elliptically polarizing plate according to the present invention;

FIGS. 6A and 6B are schematic views showing yet another step in the example of a method of producing an elliptically polarizing plate according to the present invention;

FIG. 7 is a schematic view showing still yet another step in the example of a method of producing an elliptically polarizing plate according to the present invention;

FIG. 8 is a schematic sectional view of a liquid crystal panel used for a liquid crystal display apparatus according to the preferred embodiment of the present invention; and

FIGS. 9A and 9B are schematic sectional views explaining an alignment state of liquid crystal molecules in VA mode.

### DESCRIPTION ON OF SYMBOLS

10 Elliptically Polarizing Plate
11 Polarizer
12 Protective Layer
13 First Birefringent Layer
14 Second Birefringent Layer
15 Second Protective Layer
20 Liquid Crystal Cell
100 Liquid Crystal Panel

### BEST MODE FOR CARRYING OUT THE INVENTION

A. Elliptically Polarizing Plate

A-1. Entire Constitution of Elliptically Polarizing Plate

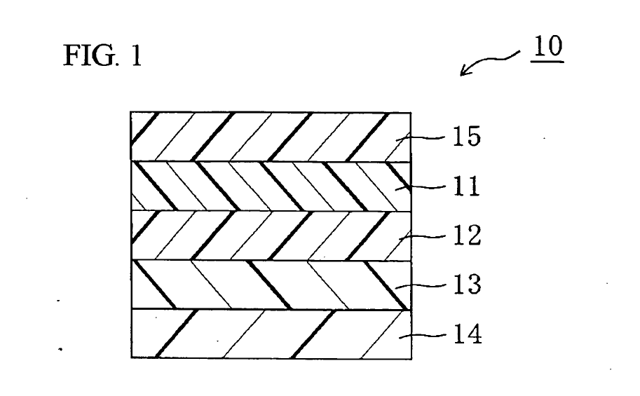

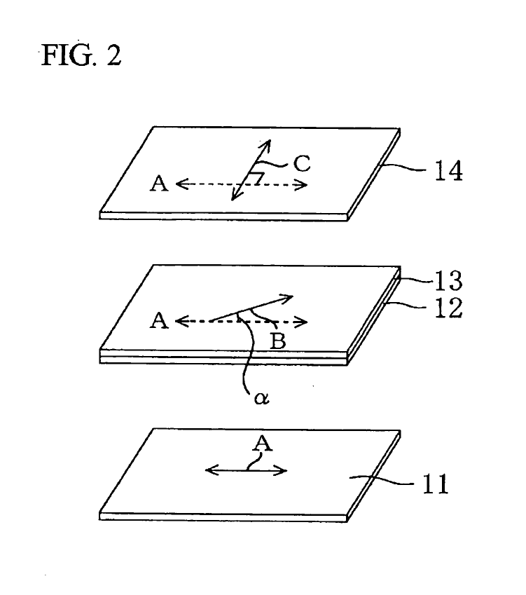

FIG. 1 is a schematic sectional view of an elliptically polarizing plate according to a preferred embodiment of the present invention. FIG. 2 is an exploded perspective view explaining optical axes of respective layers forming the elliptically polarizing plate of FIG. 1. As shown in FIG. 1, an elliptically polarizing plate 10 includes a polarizer 11, a protective layer (transparent protective film) 12, a first birefringent layer (optical compensation layer) 13, and a second birefringent layer (optical compensation layer) 14. For practical use, the elliptically polarizing plate of the present invention may include a second protective layer (transparent protective film) 15 on a side without the protective layer (transparent protective film) 12 laminated of the polarizer.

The first birefringent layer 13 may serve as a so-called λ/2 plate. In the specification of the present invention, the λ/2 plate refers to a plate having a function of converting linearly polarized light having a specific vibration direction into linearly polarized light having a vibration direction perpendicular thereto, or converting right-handed circularly polarized light into left-handed circularly polarized light (or converting left-handed circularly polarized light into right-handed circularly polarized light). The second birefringent layer 14 may serve as a so-called λ/4 plate. In the specification of the present invention, the λ/4 plate refers to a plate having a function of converting linearly polarized light having a specific wavelength into circularly polarized light (or converting circularly polarized light into linearly polarized light).

FIG. 2 is an exploded perspective view explaining optical axes of respective layers forming the elliptically polarizing plate according to a preferred embodiment of the present invention (In FIG. 2, the second protective layer 15 is omitted for clarity). The first birefringent layer 13 is laminated such that its slow axis B is defined at a predetermined angle α with respect to an absorption axis A of the polarizer 11. The angle α is preferably +80 to +38° or −8° to −38°, more preferably +1320 to +33° or −13° to −33°, particularly preferably +19° to +29° or −19° to −29°, especially preferably +21° to +27° or −21° to −27°, and most preferably +23° to +24° or −23° to −24°. The first birefringent layer and the polarizer are laminated at such an angle α as described above, to thereby provide a polarizing plate with excellent circularly polarization properties. As shown in FIG. 2, the second birefringent layer 14 is laminated such that its slow axis C is substantially perpendicular to the absorption axis A of the polarizer 11. In the specification of the present invention, the phrase “substantially perpendicular” includes a case at an angle of 90°±2.0°, preferably 90°±1.0°, and more preferably 90°±0.5°.

The elliptically polarizing plate of the present invention has a total thickness of preferably 80 to 200 μm, more preferably 90 to 130 μm, and most preferably 100 to 120 μm. According to the present invention, the first birefringent layer and the second birefringent layer are each formed of a liquid crystal material (described below). Thus, a thickness of the first birefringent layer for causing the first birefringent layer to serve as a λ/2 plate may be reduced remarkably as compared to the conventional one, and a thickness of the second birefringent layer for causing the second birefringent layer to serve as a λ/4 plate may be reduced remarkably as compared to the conventional one. As a result, the elliptically polarizing plate of the present invention may have a remarkably reduced thickness of a minimum of about ¼ of a total thickness of the conventional elliptically polarizing plate, and may greatly contribute to reduction in thickness of an image display apparatus. Hereinafter, details of the respective layers forming the elliptically polarizing plate of the present invention will be described.

A-2. First Birefringent Layer

As described above, the first birefringent layer 13 may serve as a so-called λ/2 plate. The first birefringent layer serves as a λ/2 plate, to thereby appropriately adjust retardation of wavelength dispersion properties (in particular, a wavelength range in which the retardation departs from λ/4) of the second birefringent layer serving as a λ/4 plate. An in-plane retardation (Δnd) of the first birefringent layer at a wavelength of 590 nm is preferably 185 to 305 nm, more preferably 205 to 285 nm, and most preferably 220 to 270 nm. The in-plane retardation (And) may be determined by an expression Δnd=(nx−ny)×d. In the expression, nx represents a refractive index in a direction providing a maximum in-plane refractive index (that is, a slow axis direction), and ny represents an in-plane refractive index in a direction perpendicular to the slow axis. D represents a thickness of the first birefringent layer. The first birefringent layer 13 preferably has a refractive index profile of nx>ny=nz. In the specification of the present invention, the expression “ny=nz” refers to not only a case where ny and nz are exactly equal but also a case where ny and nz are substantially equal. In the specification of the present invention, the phrase “substantially equal” includes a case where nx and ny differ without providing effects on overall polarization properties of an elliptically polarizing plate in practical use.

A thickness of the first birefringent layer is set such that it serves as a λ/2 plate most appropriately. That is, the thickness thereof is set to provide a desired in-plane retardation. To be specific, the thickness is preferably 0.5 to 5 μm, more preferably 1 to 4 μm, and most preferably 1.5 to 3 μm.

An arbitrary and appropriate material may be used as a material forming the first birefringent layer as long as the above characteristics are provided. A liquid crystal material is preferable, and a liquid crystal material (nematic liquid crystal) having a nematic phase as a liquid crystal phase is more preferable. Examples of the liquid crystal material which can be used include a liquid crystal polymer and a liquid crystal monomer. Liquid crystallinity of the liquid crystal material may develop through a lyotropic mechanism or a thermotropic mechanism. Further, an alignment state of the liquid crystal is preferably homogeneous alignment.

A liquid crystal monomer used as the liquid crystal material is preferably a polymerizable monomer or a crosslinking monomer, for example. As described below, this is because the alignment state of the liquid crystal material can be fixed by polymerizing or crosslinking the polymerizable monomer or the crosslinking monomer. The alignment state of the liquid crystal material can be fixed by aligning the liquid crystal monomer, and then polymerizing or crosslinking the liquid crystal monomers (polymerizable monomers or crosslinking monomers), for example. A polymer is formed through polymerization, and a three-dimensional network structure is formed through crosslinking. However, the polymer and the three-dimensional network structure are not crystalline. Thus, the formed first birefringent layer will not undergo phase transition into a liquid crystal phase, a glass phase, or a crystal phase by change in temperature, which is specific to a liquid crystal compound. As a result, the first birefringent layer is a birefringent layer which has excellent stability and is not affected by change in temperature.

Any suitable liquid crystal monomers may be employed as the liquid crystal monomer. For example, there are used polymerizable mesogenic compounds and the like described in JP 2002-533742 A (WO 00/37585), EP 358208 (U.S. Pat. No. 5,211,877), EP 66137 (U.S. Pat. No. 4,388,453), WO93/22397, EP 0261712, DE 19504224, DE 4408171, GB 2280445, and the like. Specific examples of the polymerizable mesogenic compounds include: LC242 (trade name) available from BASF Aktiengesellschaft; E7 (trade name) available from Merck & Co., Inc.; and LC-Silicone-CC3767 (trade name) available from Wacker-Chemie GmbH.

For example, a nematic liquid crystal monomer is preferred as the liquid crystal monomer, and a specific example thereof includes a monomer represented by the below-indicated formula (1). The liquid crystal monomer may be used alone or in combination of two or more thereof.

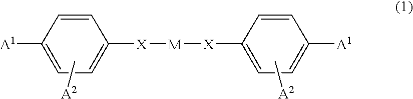

In the above formula (1), A¹ and A² each represent a polymerizable group, and may be the same or different from each other. One of A¹ and A² may represent hydrogen. Each X independently represents a single bond, —O—, —S—, —C═N—, —O—CO—, —CO—O—, —O—CO—O—, —CO—NR—, —NR—CO—, —NR—, —O—CO—NR—, —NR—CO—O—, —CH₂—O—, or —NR—CO—NR—. R represents H or an alkyl group having 1 to 4 carbon atoms. M represents a mesogen group.

In the above formula (1), Xs may be the same or different from each other, but are preferably the same.

Of monomers represented by the above formula (1), each A² is preferably arranged in an ortho position with respect to A¹.

A¹ and A² are preferably each independently represented by the below-indicated formula (2), and A¹ and A² preferably represent the same group.
Z-X-(Sp)ₙ (2)

In the above formula (2), Z represents a crosslinkable group, and X is the same as that defined in the above formula (1). Sp represents a spacer consisting of a substituted or unsubstituted linear or branched alkyl group having 1 to 30 carbon atoms. n represents 0 or 1. A carbon chain in Sp may be interrupted by oxygen in an ether functional group, sulfur in a thio ether functional group, a non-adjacent imino group, an alkylimino group having 1 to 4 carbon atoms, or the like.

In the above formula (2), Z preferably represents any one of functional groups represented by the below-indicated formulae. In the below-indicated formulae, examples of R include a methyl group, an ethyl group, an n-propyl group, an i-propyl group, an n-butyl group, an i-butyl group, and a t-butyl group.

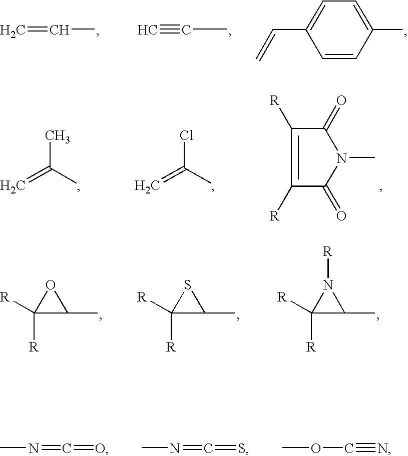

In the above formula (2), Sp preferably represents any one of structural units represented by the below-indicated formulae. In the below-indicated formulae, m preferably represents 1 to 3, and p preferably represents 1 to 12.

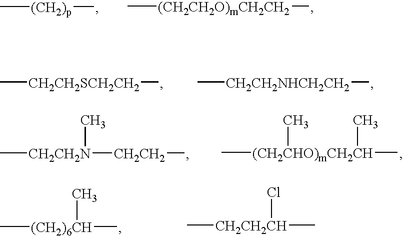

In the above formula (1), M is preferably represented by the below-indicated formula (3) In the below-indicated formula (3), X is the same as that defined in the above formula (1). Q represents a substituted or unsubstituted linear or branched alkylene group, or an aromatic hydrocarbon group, for example. Q may represent a substituted or unsubstituted linear or branched alkylene group having 1 to 12 carbon atoms, for example.

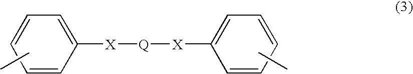

In the case where Q represents an aromatic hydrocarbon group, Q preferably represents any one of aromatic hydrocarbon groups represented by the below-indicated formulae or substituted analogues thereof.

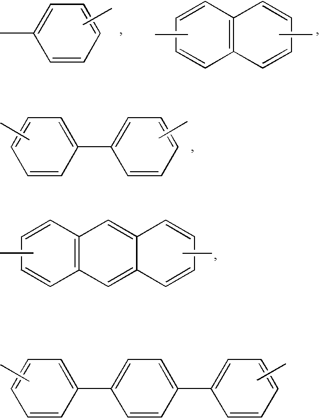

The substituted analogues of the aromatic hydrocarbon groups represented by the above formulae may each have 1 to 4 substitutents per aromatic ring, or 1 to 2 substitutents per aromatic ring or group. The substitutents may be the same or different from each other. Examples of the substitutents include: an alkyl group having 1 to 4 carbon atoms; a nitro group; a halogen group such as F, Cl, Br, or I; a phenyl group; and an alkoxy group having 1 to 4 carbon atoms.

Specific examples of the liquid crystal monomer include monomers represented by the following formulae (4) to (19).

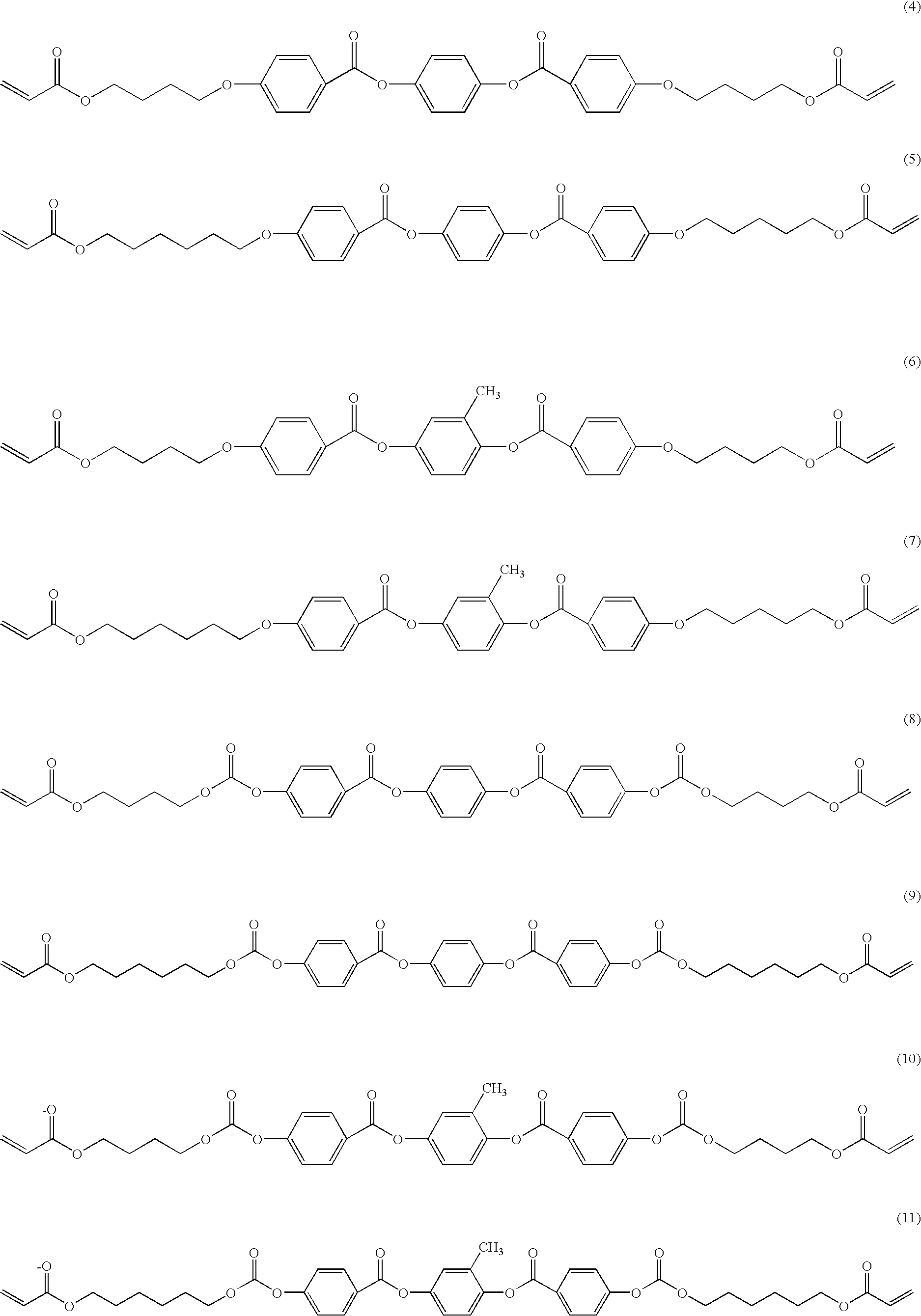

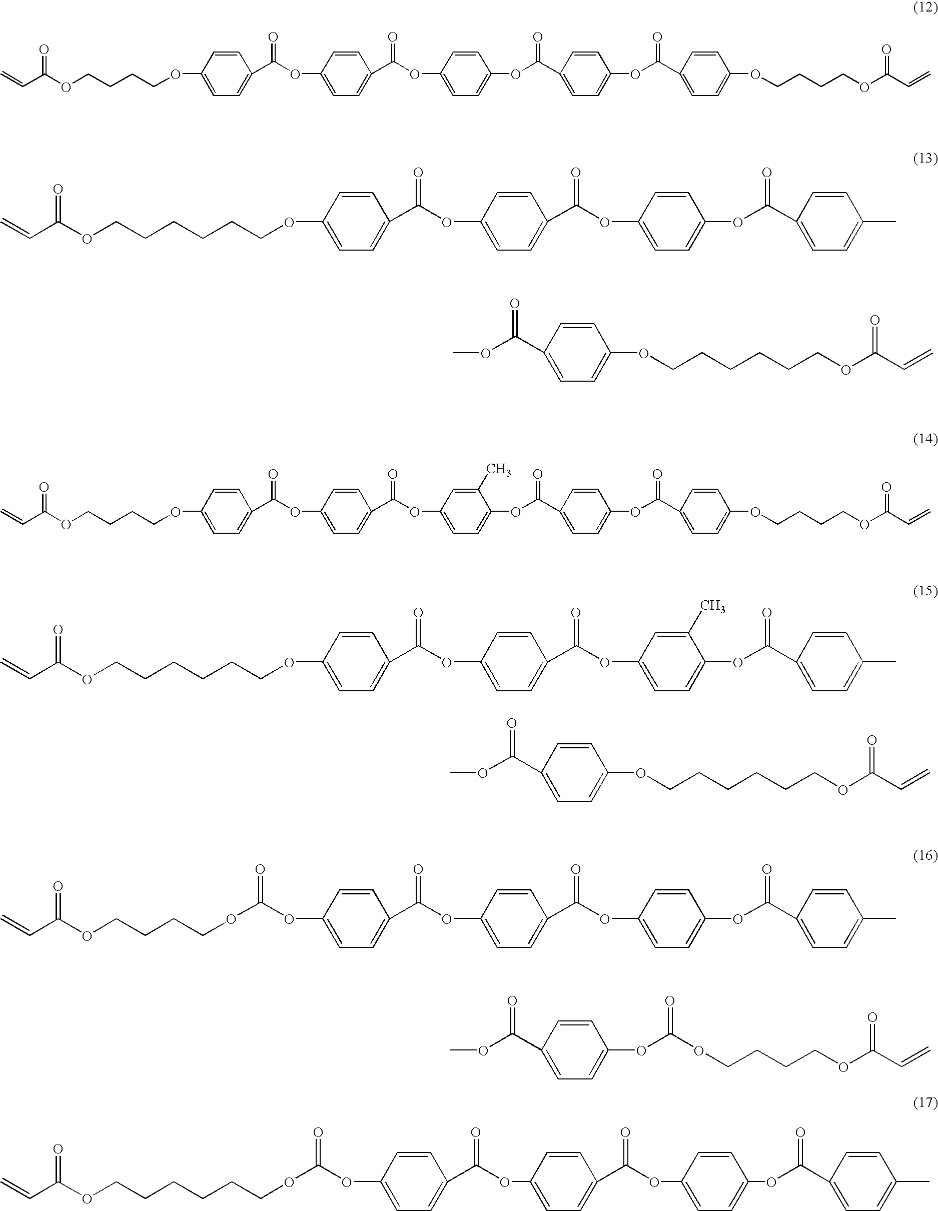

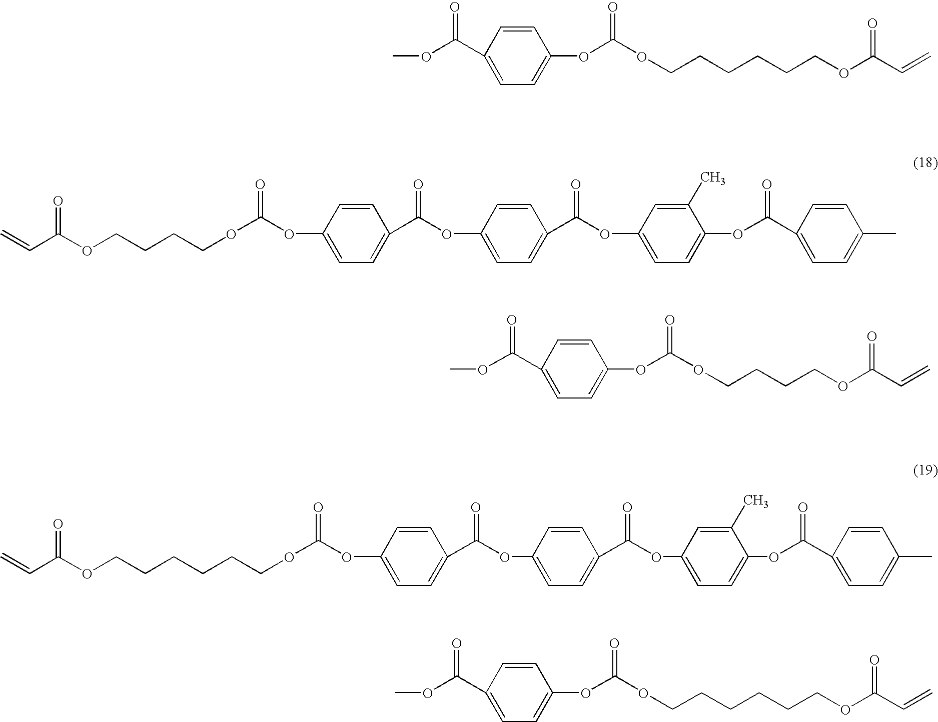

A temperature range in which the liquid crystal monomer exhibits liquid-crystallinity varies depending on the type of liquid crystal monomer. More specifically, the temperature range is preferably 40 to 120° C., more preferably 50 to 100° C., and most preferably 60 to 90° C.

A-3. Second Birefringent Layer

As described above, the second birefringent layer 14 may serve as a so-called λ/4 plate. According to the present invention, the wavelength dispersion characteristics of the second birefringent layer serving as a λ/4 plate are corrected by optical characteristics of the first birefringent layer serving as a λ/2 plate, to thereby exhibit circularly polarizing function over a wide wavelength range. An in-plane retardation (And) of the second birefringent layer at a wavelength of 590 nm is preferably 60 to 180 nm, more preferably 80 to 160 nm, and most preferably 100 to 140 nm. Further, the second birefringent layer 14 preferably has a refractive index profile of nx>ny=nz.

The thickness of the second birefringent layer may be set such that the second birefringent layer may serve as a λ/4 plate most appropriately. That is, the thickness thereof may be set to provide a desired in-plane retardation. To be specific, the thickness thereof is preferably 0.3 to 3 μm, more preferably 0.5 to 2.5 μm, and most preferably 0.8 to 2 μm. Realization of such a very thin second birefringent layer (λ/4 plate) is one feature of the present invention. For example, the elliptically polarizing plate of the present invention may realize a X/4 plate (second birefringent layer) having a thickness of about 1/20 to 1/200 of that of a λ/4 plate formed of a conventional stretched film having a thickness of about 60 μm.

Any appropriate material may be employed for a material used for forming the second birefringent layer as long as such characteristics as described above are obtained. A liquid crystal material is preferred because a difference between nx and ny may be increased remarkably compared with that of a conventional stretched polymer film (such as a norbornene-based resin or a polycarbonate-based resin), to thereby remarkably reduce a thickness of the second birefringent layer for providing an in-plane retardation desired for a λ/4 plate. The same material as that used for the first birefringent layer may be used as the liquid crystal. The details of the liquid crystal material are as described in the above section A-2.

A-4. Polarizer

Any suitable polarizers may be employed as the polarizer 11 in accordance with the purpose. Examples thereof include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based orientation film such as a dehydrated product of a polyvinyl alcohol-based film or a dechlorinated product of a polyvinyl chloride-based film. Of those, a polarizer prepared by adsorbing a dichromatic substance such as iodine on a polyvinyl alcohol-based film and uniaxially stretching the film is particularly preferred because of high polarized dichromaticity. A thickness of the polarizer is not particularly limited, but is generally about 1 to 80 μm.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

Washing the polyvinyl alcohol-based film with water not only allows removal of contamination or an antiblocking agent on a film surface, but also provides an effect of preventing nonuniformity such as uneven coloring by swelling of the polyvinyl alcohol-based film. The stretching of the film may be performed after coloring of the film with iodine, performed during coloring of the film, or performed followed by coloring of the film with iodine. The stretching may be performed in an aqueous solution of boric acid or potassium iodide, or in a water bath.

A-5. Protective Layer

The protective layer 12 and the second protective layer 15 are each formed of an arbitrary and appropriate film which can be used as a protective layer for a polarizing plate. The film is preferably a transparent protective film. Specific examples of a material used as a main component of the film include transparent resins such as a cellulose-based resin (such as triacetylcellulose (TAC)), a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, an acrylic resin, and an acetate-based resin. Another example thereof includes an acrylic, urethane-based, acrylic urethane-based, epoxy-based, or silicone-based thermosetting resin or UV-curing resin. Still another example thereof includes a glassy polymer such as a siloxane-based polymer. Further, a polymer film described in JP 2001-343529 A (WO 01/37007) may also be used. To be specific, the film is formed of a resin composition containing a thermoplastic resin having a substituted or unsubstituted imide group on a side chain, and a thermoplastic resin having a substituted or unsubstituted phenyl group and a nitrile group on a side chain. A specific example thereof includes a resin composition containing an alternate copolymer of isobutene and N-methylmaleimide, and an acrylonitrile/styrene copolymer. The polymer film may be an extruded product of the above-mentioned resin composition, for example. Of those, TAC, a polyimide-based resin, a polyvinyl alcohol-based resin, and a glassy polymer are preferable, and TAC is most preferable.

The protective layer is preferably transparent and colorless. To be specific, the protective layer has a thickness direction retardation Rth of preferably −90 nm to +90 nm, more preferably −80 nm to +80 nm, and most preferably −70 nm to +70 nm. The thickness direction retardation Rth may be determined by an expression Rth={(nx+ny)/2−nz}xd.

The protective layer has an arbitrary and appropriate thickness as long as the preferable thickness direction retardation can be obtained. To be specific, the thickness of the protective layer is preferably 5 mm or less, more preferably 1 mm or less, even more preferably 1 to 500 μm, and most preferably 5 to 150 μm.

The surface of the second protective layer 15 opposite to that of the polarizer (that is, the outermost part of the elliptically polarizing plate) may be subjected to hard coat treatment, antireflection treatment, anti-sticking treatment, anti-glare treatment, or the like as required.

B. Method of Producing Elliptically Polarizing Plate

A method of producing an elliptically polarizing plate according to a preferred embodiment of the present invention includes the steps of: subjecting a surface of a transparent protective film (T) to alignment treatment; forming a first birefringent layer on the surface of the transparent protective film (T) subjected to the alignment treatment; laminating a polarizer on a surface of the transparent protective film (T); and laminating a second birefringent layer on the surface of the first birefringent layer. In the method, the polarizer and the first birefringent layer are arranged on opposite sides of the transparent protective film (T). Such a production method provides an elliptically polarizing plate shown in FIG. 1 or 2. The order of the steps and/or the film to be subjected to the alignment treatment may appropriately be changed in accordance with the purpose. For example, the step of laminating a polarizer may be performed after the step of forming any one of birefringent layers or after the step of laminating any one of birefringent layers. Further, the transparent protective film may be subjected to the alignment treatment, or any appropriate substrate may be subjected thereto, for example. In the case where the substrate is subjected to the alignment treatment, a film formed on the substrate (to be specific, the first birefringent layer) may be transferred (laminated) in an appropriate order in accordance with a desired laminate structure of the elliptically polarizing plate. Hereinafter, the details of the respective steps will be described.

B-1. Alignment Treatment for Transparent Protective Film

A surface of a transparent protective film (T) (eventually, the protective layer 12) is subjected to alignment treatment, and an application liquid containing a predetermined liquid crystal material is applied onto the surface, to thereby form the first birefringent layer 13 having a slow axis at an angle α with respect to the absorption axis of the polarizer 11 as shown in FIG. 2 (the step of forming a first birefringent layer is described below).

Arbitrary and appropriate alignment treatment may be employed as the alignment treatment for the transparent protective film (T). Specific examples of the alignment treatment include rubbing treatment, an oblique deposition method, stretching treatment, photoalignment treatment, magnetic field alignment treatment, and electrical field alignment treatment. The rubbing treatment is preferable. Arbitrary and appropriate conditions may be employed as conditions for various alignment treatments in accordance with the purpose.

The alignment direction of the alignment treatment refers to a direction at a predetermined angle with respect to the absorption axis of the polarizer when the transparent protective film (T) and the polarizer are laminated. The alignment direction is substantially the same as the direction of the slow axis B of the first birefringent layer 13 to be formed as described below. Thus, the predetermined angle is preferably +8° to +38° or −8° to −38°, more preferably +13° to +33° or −13° to −33°, particularly preferably +19° to +29° or −19° to −29°, especially preferably +21° to +27° or —21° to −27°, and most preferably +23° to +24° or −23° to −24°.

The alignment treatment at such a predetermined angle as described above with respect to a continuous transparent protective film (T) involves treatment in a longitudinal direction of the continuous transparent protective film (T) and treatment in an oblique direction (to be specific, direction at such a predetermined angle as described above) with respect to the longitudinal direction or direction perpendicular thereto (width direction) of the continuous protective film (T). The polarizer is produced by stretching the polymer film colored with a dichromatic substance as described above, and has an absorption axis in the stretching direction. For mass production of the polarizer, a continuous polymer film is prepared and is continuously stretched in a longitudinal direction. In a case where a continuous polarizer and a continues transparent protective film (T) are attached together, longitudinal directions thereof are in the direction of the absorption axis of the polarizer. Thus, in order to align the transparent protective film (T) in a direction at a predetermined angle with respect to the absorption axis of the polarizer, the transparent protective film is desirably subjected to the alignment treatment in an oblique direction. The direction of the absorption axis of the polarizer and the longitudinal directions of the continuous films (polarizer and transparent protective film (T)) are substantially the same, and thus the direction of the alignment treatment may be at the above predetermined angle with respect to the longitudinal directions. Meanwhile, in a case where the treatment is performed in a longitudinal direction or width direction of the transparent protective film, the transparent protective film must be cut out in an oblique direction and then laminated. As a result, angles between optical axes may vary by cut-out film. The variation may result in variation in quality by product, production requiring high cost and long time, increased waste, and difficulties in production of large films.

The surface of the transparent protective film (T) may be directly subjected to the alignment treatment. Alternatively, an arbitrary and appropriate aligned film (typified by a polyimide layer or a polyvinyl alcohol layer) may be formed, and the aligned film may be subjected to the alignment treatment.

B-2. Step of Applying Liquid Crystal Composition Forming First Birefringent Layer

Next, an application liquid (liquid crystal composition) containing a liquid crystal material as described in the section A-2 is applied onto the surface of the transparent protective film (T) which has been subjected to the alignment treatment. Then, the liquid crystal material in the application liquid is aligned to form the first birefringent layer. More specifically, an application liquid having a liquid crystal material dissolved or dispersed in an appropriate solvent may be prepared, and the application liquid may be applied onto the surface of the transparent protective film (T) which has been subjected to the alignment treatment. The step of aligning the liquid crystal material is described in the section B-3 below.

Any suitable solvents which may dissolve or disperse the liquid crystal material may be employed as the solvent. The type of solvent to be used may be appropriately selected in accordance with the type of liquid crystal material or the like. Specific examples of the solvent include: halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, mesitylene, methoxybenzene, and 1,2-dimethoxybenzene; ketone-based solvents such as acetone, methyl ethyl ketone (MEK), methyl isobutyl ketone, cyclohexanone, cyclopentanone, 2-pyrrolidone, and N-methyl-2-pyrrolidone; ester-based solvents such as ethyl acetate, butyl acetate, and propyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide-based solvents such as dimethylformamide and dimethylacetamide; nitrile-based solvents such as acetonitrile and butyronitrile; ether-based solvents such as diethyl ether, dibutyl ether, tetrahydrofuran, and dioxane; and carbon disulfide, ethylcellosolve, butyl cellosolve, and ethyl cellosolve acetate. Of those, toluene, xylene, mesitylene, MEK, methyl isobutyl ketone, cyclohexanone, ethyl cellosolve, butyl cellosolve, ethyl acetate, butyl acetate, propyl acetate, and ethyl cellosolve acetate are preferred. The solvent may be used alone or in combination of two or more types thereof.

A content of the liquid crystal material in the liquid crystal composition (application liquid) may be appropriately determined in accordance with the type of liquid crystal material, the thickness of the target layer, and the like. More specifically, the content of the liquid crystal material is preferably 5 to 50 wt %, more preferably 10 to 40 wt %, and most preferably 15 to 30 wt %.

The liquid crystal composition (application liquid) may further contain any suitable additives as required. Specific examples of the additive include a polymerization initiator and a crosslinking agent. The additive is particularly preferably used when a liquid crystal monomer is used as the liquid crystal material. Specific examples of the polymerization initiator include benzoylperoxide (BPO) and azobisisobutyronitrile (AIBN). Specific examples of the crosslinking agent include an isocyanate-based crosslinking agent, an epoxy-based crosslinking agent, and a metal chelate crosslinking agent. Such additive may be used alone or in combination of two or more thereof. Specific examples of other additives include an antioxidant, a modifier, a surfactant, a dye, a pigment, a discoloration inhibitor, and a UV absorber. Such additive may also be used alone or in combination of two or more thereof. Examples of the antioxidant include a phenol-based compound, an amine-based compound, an organic sulfur-based compound, and a phosphine-based compound. Examples of the modifier include glycols, silicones, and alcohols. The surfactant is used for smoothing a surface of an optical film (that is, the first birefringent layer to be formed), for example. Specific examples thereof include a silicone-based surfactant, an acrylic surfactant, and a fluorine-based surfactant.

An application amount of the application liquid may be appropriately determined in accordance with a concentration of the application liquid, the thickness of the target layer, and the like. In a case where the concentration of the liquid crystal material is 20 wt % in the application liquid, the application amount is preferably 0.03 to 0.17 ml, more preferably 0.05 to 0.15 ml, and most preferably 0.08 to 0.12 ml per 100 cm² of the transparent protective film (T).

Any suitable application methods may be employed, and specific examples thereof include roll coating, spin coating, wire bar coating, dip coating, extrusion, curtain coating, and spray coating.

B-3. Step of Aligning Liquid Crystal Material Forming First Birefringent Layer

Next, the liquid crystal material forming the first birefringent layer is aligned in accordance with the alignment direction of the surface of the transparent protective film (T). The liquid crystal material is aligned through treatment at a temperature at which the liquid crystal material exhibits a liquid crystal phase in accordance with the type of liquid crystal material used. The treatment at such a temperature allows the liquid crystal material to be in a liquid crystal state, and the liquid crystal material is aligned in accordance with the alignment direction of the surface of the transparent protective film (T). Thus, birefringence is caused in the layer formed through application, to thereby form the first birefringent layer.

As described above, a treatment temperature may be arbitrarily determined in accordance with the type of liquid crystal material. To be specific, the treatment temperature is preferably 40 to 120° C., more preferably 50 to 100° C., and most preferably 60 to 90° C. A treatment time is preferably 30 seconds or more, more preferably 1 minute or more, particularly preferably 2 minutes or more, and most preferably 4 minutes or more. A treatment time of less than 30 seconds may provide an insufficient liquid crystal state of the liquid crystal material. Meanwhile, the treatment time is preferably 10 minutes or less, more preferably 8 minutes or less, and most preferably 7 minutes or less. A treatment time exceeding 10 minutes may cause sublimation of additives.

In a case where the liquid crystal monomer (polymerizable monomer or crosslinking monomer) as described in the section A-2 is used as the liquid crystal material, the layer formed through the application is preferably subjected to polymerization treatment or crosslinking treatment. The polymerization treatment allows the liquid crystal monomer to polymerize and to be fixed as a repeating unit of a polymer molecule. The crosslinking treatment allows the liquid crystal monomer to form a three-dimensional structure and to be fixed as a part of a crosslinked structure. As a result, the alignment state of the liquid crystal material is fixed. The polymer or three-dimensional structure formed through polymerization or crosslinking of the liquid crystal monomer is “non-liquid crystal”. Thus, the formed first birefringent layer will not undergo phase transition into a liquid crystal phase, a glass phase, or a crystal phase by change in temperature, which is specific to a liquid crystal molecule. As a result, the first birefringent layer which is not affected by change in temperature and has excellent stability can be obtained.

A specific procedure for the polymerization treatment or crosslinking treatment may be arbitrarily selected in accordance with the type of polymerization initiator or crosslinking agent to be used. For example, in a case where a photopolymerization initiator or a photocrosslinking agent is used, photoirradiation may be performed. In a case where a UV polymerization initiator or a UV crosslinking agent is used, UV irradiation may be performed. In a case where a polymerization initiator or crosslinking agent based on heat is used, heating may be performed. The irradiation time, irradiation intensity, total amount of irradiation, and the like of light or UV light may be arbitrarily set in accordance with the type of liquid crystal material, the type of transparent protective film (T), the type of alignment treatment, desired characteristics for the first birefringent layer, and the like. A heating temperature, a heating time, and the like may be arbitrarily set in the same manner.

Such alignment treatment is performed to align the liquid crystal material in the alignment direction of the transparent protective film (T). Thus, the direction of the slow axis B of the first birefringent layer formed is substantially the same as the alignment direction of the transparent protective film (T). The direction of the slow axis B of the first birefringent layer is preferably +8° to +38° or −8° to −38°, more preferably +13° to +33° or −13° to −33°, particularly preferably +19° to +29° or −19° to −29°, especially preferably +21° to +27° or −21° to −27°, and most preferably +23° to +24° or −23° to −24° with respect to the longitudinal direction of the transparent protective film (T).

B-4. Step of Laminating Polarizer

The polarizer is laminated on the surface of the transparent protective film (T). As described above, the polarizer is laminated at an arbitrary and appropriate point in time in the production method of the present invention. For example, the polarizer may be laminated on the transparent protective film (T) in advance, may be laminated after the first birefringent layer is formed, or may be laminated after the second birefringent layer is formed.

An arbitrary and appropriate lamination method (such as adhesion) may be employed as a method of laminating the transparent protective film (T) and the polarizer. The adhesion may be performed by using an arbitrary and appropriate adhesive or pressure sensitive adhesive. The type of adhesive or pressure sensitive adhesive may be arbitrarily selected in accordance with the type of adherend (that is, transparent protective film (T) and polarizer). Specific examples of the adhesive include: acrylic, vinyl alcohol-based, silicone-based, polyester-based, polyurethane-based, and polyether-based polymer adhesives; isocyanate-based adhesives; and rubber-based adhesives. Specific examples of the pressure sensitive adhesive include acrylic, vinyl alcohol-based, silicone-based, polyester-based, polyurethane-based, polyether-based, isocyanate-based, and rubber-based pressure sensitive adhesives.

A thickness of the adhesive or pressure sensitive adhesive is not particularly limited, but is preferably 10 to 200 nm, more preferably 30 to 180 nm, and most preferably 50 to 150 nm.

According to the production method of the present invention, the slow axis of the first birefringent layer may be set in the alignment treatment for the transparent protective film (T). Thus, a continuous polarizing film (polarizer) stretched in a longitudinal direction (that is, film having an absorption axis in the longitudinal direction) can be used. In other words, a continuous transparent protective film (T) subjected to the alignment treatment at a predetermined angle with respect to its longitudinal direction and a continuous polarizing film (polarizer) may be continuously attached together with the respective longitudinal directions in the same direction (so-called roll-to-roll). Thus, an elliptically polarizing plate can be obtained at very high production efficiency. According to the method of the present invention, the film need not be cut out obliquely with respect to its longitudinal direction (stretching direction) for lamination. As a result, angles of optical axes do not vary by cut-out film, resulting in an elliptically polarizing film without variation in quality by product. Further, no wastes are produced by cutting of the film, and the elliptically polarizing plate can be obtained at low cost and production of a large polarizing plate is facilitated.

Note that the direction of the absorption axis of the polarizer is substantially parallel to the longitudinal direction of the continuous film. In the specification of the present invention, the phrase “substantially parallel” includes a case where the longitudinal direction and the direction of the absorption axis form an angle of 0°±10°, preferably 0°±5°, and more preferably 0°±3°.

B-5. Step of Laminating Second Birefringent Layer

The second birefringent layer is laminated on the surface of the first birefringent layer. A detailed procedure for the step of laminating a second birefringent layer is described below. First, an application liquid containing a liquid crystal material used for forming the second birefringent layer is applied to a substrate, and the liquid crystal material is aligned on the substrate. The alignment of the liquid crystal material is performed through treatment at a temperature at which the liquid crystal material exhibits a liquid crystal phase in accordance with the type of liquid crystal material used. Through such temperature treatment, the liquid crystal material converts into a liquid crystal state, and the liquid crystal material aligns in accordance with the alignment direction of the surface of the substrate. In this way, birefringence generates in a layer formed through application, to thereby form the second birefringent layer. The details of the application of the application liquid and the alignment treatment of the liquid crystal material are as described in the above sections B-2 and B-3. However, the thickness of the second birefringent layer is about half the thickness of the first birefringent layer, and thus the application amount is also reduced to about half. To be specific, the application amount is preferably 0.02 to 0.08 ml, more preferably 0.03 to 0.07 ml, and most preferably 0.04 to 0.06 ml per area (100 cm²) of the substrate.

Any appropriate substrate may be used for the substrate as long as an appropriate second birefringent layer of the present invention can be obtained. The substrate is preferably a polyethylene terephthalate (PET) film obtained through stretching treatment and recrystallization treatment. To be specific, a PET resin is formed into an extruded film, stretched, and recrystallized, to thereby obtain a substrate. The stretching method is preferably transverse uniaxial stretching or longitudinal and transverse biaxial stretching. In the longitudinal and transverse biaxial stretching, a stretch ratio in a transverse direction is preferably larger than a stretch ratio in a longitudinal direction. Such a method provides a substrate having an alignment axis in a width direction. The substrate may be stretched after a polyimide layer or a polyvinyl alcohol layer is formed thereon. A stretching temperature is preferably 120 to 160° C., and the stretch ratio is preferably 2 to 7 times. A stretching direction may be set in accordance with a desired direction of the slow axis of the second birefringent layer. In the present invention, the slow axis of the first birefringent layer may be set in any appropriate oblique direction with respect to the absorption axis (longitudinal direction of the continuous film) of the polarizer. Here, in the case where the slow axis of the first birefringent layer is set in a direction of 23° to 24° with respect to the absorption axis of the polarizer, the slow axis of the second birefringent layer only needs to be substantially perpendicular to the absorption axis of the polarizer. The direction of the slow axis corresponds to a direction of the alignment axes of the substrate (direction in which the liquid crystal material used for forming the second birefringent layer is aligned), and the direction of the alignment axes of the substrate corresponds to the stretching direction. Thus, the stretching of the substrate only needs to be performed in a transverse direction (width direction: direction perpendicular to the longitudinal direction: direction perpendicular to the absorption axis of the polarizer). As a result, the second birefringent layer needs not be punched out for aligning the direction of the slow axis, and may be attached by roll-to-roll, to thereby further improve the production efficiency. A recrystallization temperature is preferably 150 to 250° C. The recrystallization is performed within such a temperature range, to thereby set directions of PET molecules in the same direction and provide a substrate having a very small variation in alignment axis. The substrate has a thickness of preferably 20 to 100 μm, more preferably 30 to 90 μm, and most preferably 30 to 80 μm. The substrate has a thickness within the above ranges, and thus provides strength for favorably supporting the very thin second birefringent layer in the lamination step and provides appropriately maintained operability such as sliding property or roll traveling property.

As described above, the specific stretching treatment and recrystallization treatment may be performed in combination, to thereby provide a substrate having a very small variation in alignment axis. To be specific, the variation in alignment axis of the substrate to be obtained is ±1° or less, and more preferably ±0.5° or less with respect to an average direction of the alignment axes. Such a substrate may be used, to thereby omit the alignment treatment for the surface of the substrate (such as rubbing treatment, oblique evaporation method, stretching treatment, photoalignment treatment, magnetic field alignment treatment, or electrical field alignment treatment). As a result, a very thin elliptically polarizing plate may be produced at very excellent production efficiency. Formation of the second birefringent layer by using a substrate which may omit the alignment treatment is one significant feature of the present invention. Such a substrate is available from Toray Industries, Inc. and Mitsubishi Polyester Film Corporation.

Next, the second birefringent layer formed on the substrate is transferred to the surface of the first birefringent layer. A transfer method is not particularly limited, and the second birefringent layer supported on the substrate is attached to the first birefringent layer through an adhesive, for example. Atypical example of the adhesive is a curable adhesive. Typical examples of the curable adhesive include: a photo-curable adhesive such as a UV-curable adhesive; a moisture-curable adhesive; and a heat-curable adhesive. A specific example of the heat-curable adhesive is a heat-curable resin-based adhesive formed of an epoxy resin, an isocyanate resin, a polyimide resin, or the like. A specific example of the moisture-curable adhesive is an isocyanate resin-based moisture-curable adhesive. The moisture-curable adhesive (in particular, an isocyanate resin-based moisture-curable adhesive) is preferred. The moisture-curable adhesive cures through a reaction with moisture in air, water adsorbed on a surface of an adherend, an active hydrogen group of a carboxyl group, a hydroxyl group, or the like, etc. Thus, the adhesive may be applied and then cured naturally by leaving at stand, and has excellent operability. Further, the moisture-curable adhesive requires no heating for curing, and thus the first and second birefringent layers are not heated during attaching (bonding). As a result, no heat shrinkage occurs, and thus formation of cracks during lamination or the like may significantly be prevented even in the case where the first and second birefringent layers each have a very small thickness as in the present invention. Note that the isocyanate resin-based adhesive is a general term for a polyisocyanate-based adhesive and a polyurethane resin adhesive.

For example, a commercially available adhesive may be used as the curable adhesive, or various curable resins may be dissolved or dispersed in a solvent to prepare a curable resin adhesive solution (or dispersion). In the case where the solution (or dispersion) is prepared, a ratio of the curable resin in the solution is preferably 10 to 80 wt %, more preferably 20 to 65 wt %, especially preferably 25 to 65 wt %, and most preferably 30 to 50 wt % in solid content. Any appropriate solvent may be used as the solvent to be used in accordance with the type of curable resin, and specific examples thereof include ethyl acetate, methyl ethyl ketone, methyl isobutyl ketone, toluene, and xylene. One type of solvent may be used alone, or two or more types thereof may be used in combination.

An application amount of the adhesive may appropriately be set in accordance with the purpose. For example, the application amount is preferably 0.3 to 3 ml, more preferably 0.5 to 2 ml, and most preferably 1 to 2 ml per area (cm²) of the first or second birefringent layer. After the application, the solvent in the adhesive is evaporated through natural drying or heat drying as required. A thickness of the adhesive layer to be obtained is preferably 0.1 to 20 μm, more preferably 0.5 to 15 μm, and most preferably 1 to 10 μm. Microhardness of the adhesive layer is preferably 0.1 to 0.5 GPa, more preferably 0.2 to 0.5 GPa, and most preferably 0.3 to 0.4 GPa. Correlation between Microhardness and Vickers hardness is known, and thus the Microhardness may be converted into Vickers hardness. Microhardness may be calculated from indentation depth and indentation load by using a thin-film hardness meter (trade name, MH4000 or MHA-400, for example) manufactured by NEC Corporation.

Finally, the substrate is peeled off from the second birefringent layer, to thereby complete the lamination of the first birefringent layer and the second birefringent layer. In this way, the elliptically polarizing plate of the present invention can be obtained.

B-6. Specific Production Procedure

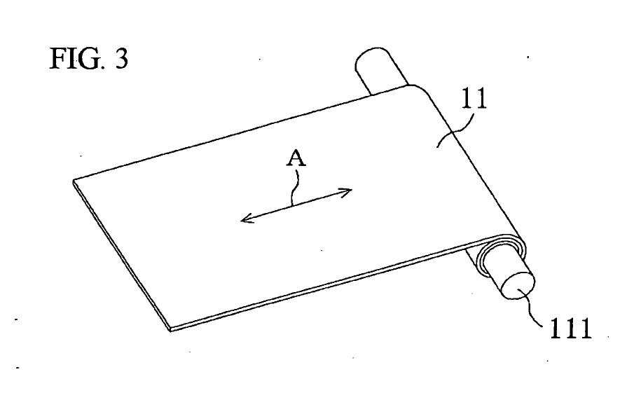

An example of a specific procedure for the production method of the present invention will be described with reference to FIGS. 3 to 7. In FIGS. 3 to 7, reference numerals 111, 111′, 112, 112′, 115, and 116 each represent a roll for rolling a film and/or laminate forming each layer.

First, a continuous polymer film is prepared as a raw material for a polarizer, and is colored, stretched, and the like as described in the section A-4. The continuous polymer film is stretched continuously in a longitudinal direction. In this way, as shown in a perspective view of FIG. 3, the continues polarizer 11 having an absorption axis in a longitudinal direction (stretching direction: direction of arrow A) is obtained.

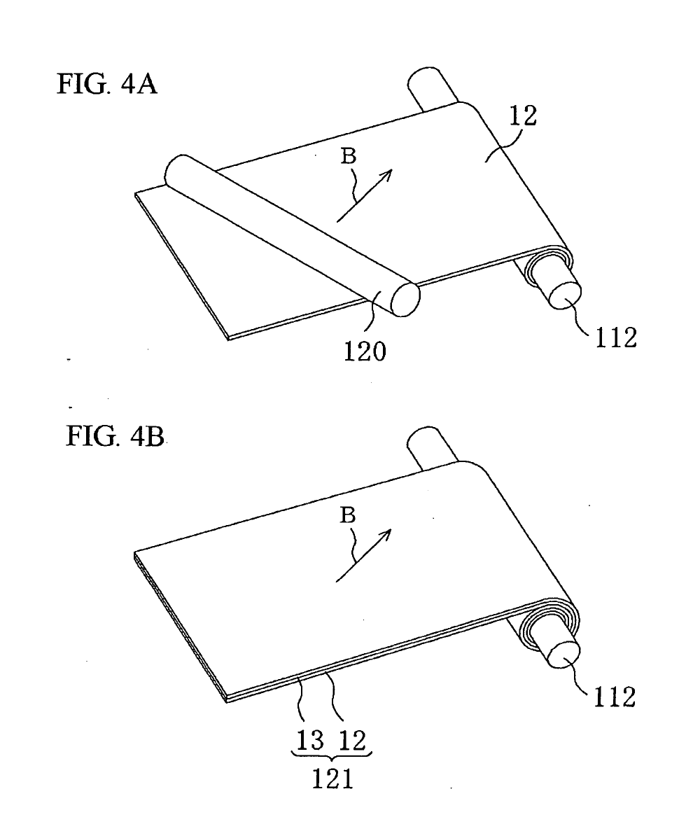

Meanwhile, as shown in a perspective view of FIG. 4A, the continuous transparent protective film 12 (eventually, the first protective layer) is prepared, and a surface of the film is subjected to rubbing treatment by using a rubbing roll 120. At this time, a rubbing direction is in a direction different from a longitudinal direction of the transparent protective film 12 such as +23° to +24° or −23° to −24°. Next, as shown in a perspective view of FIG. 4B, the first birefringent layer 13 is formed on the transparent protective film 12 subjected to the rubbing treatment as described in the sections B-2 and B-3. The first birefringent layer 13 has a liquid crystal material aligned along the rubbing direction, and the direction of its slow axis is in substantially the same direction (direction of arrow B) as the rubbing direction of the transparent protective film 12.

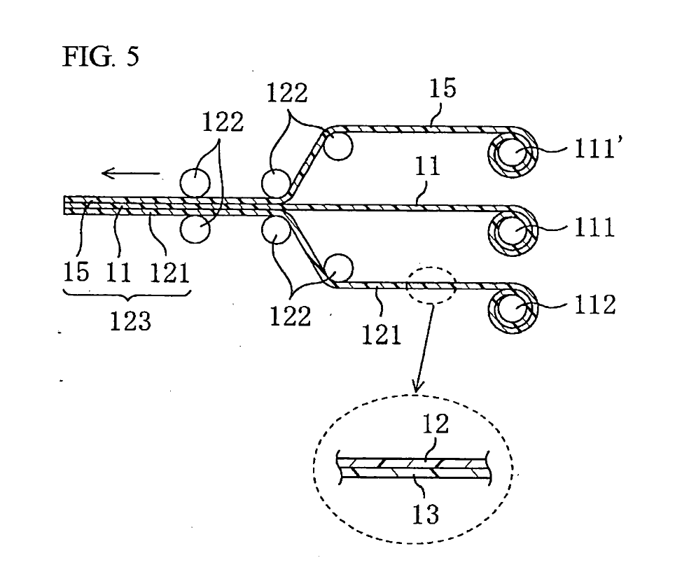

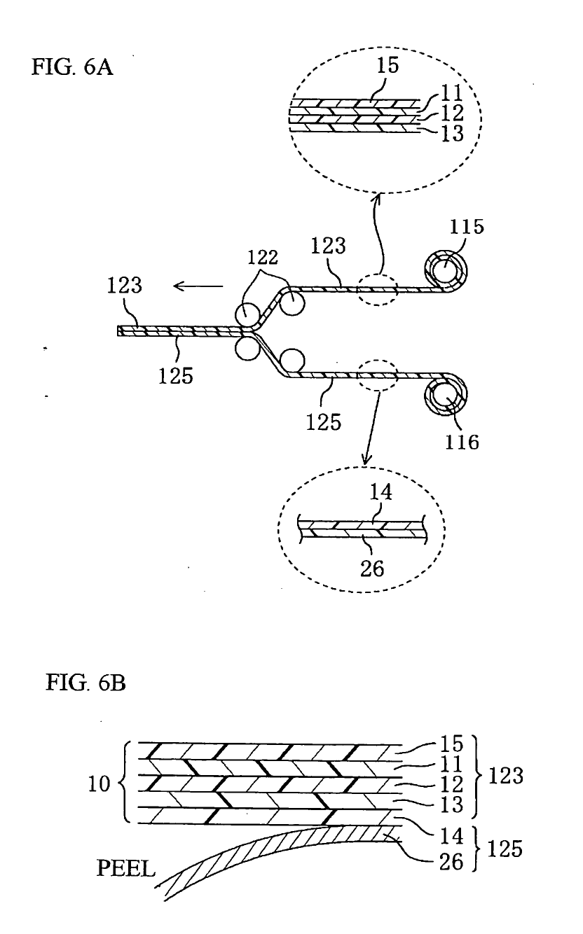

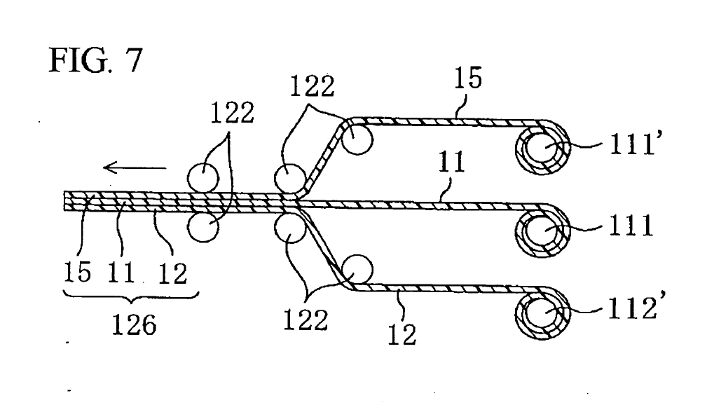

Next, as shown in a schematic diagram of FIG. 5, the transparent protective film (eventually, the second protective layer) 15, the polarizer 11, and a laminate 121 of the transparent protective film (eventually, the protective layer) 12 and the first birefringent layer 13 are delivered in a direction of an arrow, and are attached together by using an adhesive or the like (not shown) with the respective longitudinal directions in the same direction. In FIG. 5, reference numeral 122 represents a guide roll for attaching together the films (the same also applies in FIG. 6 and FIG. 7).

As shown in a schematic diagram of FIG. 6A, a continuous laminate 125 (having the second birefringent layer 14 supported on a substrate 26) is prepared. The laminate and a laminate 123 (of the second protective layer (transparent protective film) 15, the polarizer 11, the protective layer (transparent protective film) 12, and the first birefringent layer 13) are delivered in a direction of an arrow, and are attached together by using an adhesive or the like (not shown) with the respective longitudinal directions in the same direction. As described above, when the direction (angle α) of the slow axis of the first birefringent layer 13 is set to +23° to +24° or −23° to −24° with respect to the longitudinal direction of the film (absorption axis of the polarizer 11), the slow axis of the second birefringent layer 14 may be substantially perpendicular to the longitudinal direction of the film (absorption axis of the polarizer 11). As a result, the very thin first and second birefringent layers can be attached by roll-to-roll, thereby significantly improving the production efficiency.

Finally, as shown in FIG. 6B, the substrate 26 is peeled off, to thereby provide the elliptically polarizing plate 10 of the present invention.

Another example of the specific procedure for the production method of the present invention will be described.

As described above and shown in a perspective view of FIG. 3, the continuous polarizer 11 is produced.

Meanwhile, as shown in a perspective view of FIG. 4A, the continuous transparent protective film (eventually, the first protective layer) 12 is prepared, and a surface of the film is subjected to rubbing treatment by using a rubbing roll 120. At this time, a rubbing direction is in a different direction from a longitudinal direction of the transparent protective film 12 such as +23° to +24° or −23° to −24°.

Next, as shown in a schematic diagram of FIG. 7, the second transparent protective film (eventually, the second protective layer) 15, the polarizer 11, and the transparent protective film (eventually, the protective layer) 12 are delivered in a direction of an arrow, and are attached together by using an adhesive or the like (not shown) with the respective longitudinal directions in the same direction. At this time, the transparent protective film 12 subjected to the rubbing treatment is delivered such that a surface opposite to the surface subjected to the rubbing treatment faces the polarizer 11. As a result, a laminate 126 of second protective layer (transparent protective film) 15/polarizer 11/protective layer (transparent protective film) 12 can be obtained.

Then, the first birefringent layer 13 is formed (not shown) on the surface of the protective layer (transparent protective film) 12 subjected to the rubbing treatment as described in the above sections B-2 and B-3. The first birefringent layer 13 has a liquid crystal material aligned along the rubbing direction, and the direction of its slow axis is in substantially the same direction as the rubbing direction of the protective layer (transparent protective film) 12. As a result, a laminate 123 of second protective layer (transparent protective film) 15/polarizer 11/protective layer (transparent protective film) 12/first birefringent layer 13 can be obtained.

As shown in a schematic diagram of FIG. 6A, a continuous laminate 125 (having the second birefringent layer 14 supported on a substrate 26) is prepared. The laminate and a laminate 123 (of the second protective layer (transparent protective film) 15, the polarizer 11, the protective layer (transparent protective film) 12, and the first birefringent layer 13) are delivered in a direction of an arrow, and are attached together by using an adhesive or the like (not shown) with the respective longitudinal directions in the same direction. As described above, when the direction (angle α) of the slow axis of the first birefringent layer 13 is set to +23° to +24° or −23° to −24° with respect to the longitudinal direction of the film (absorption axis of the polarizer 11), the slow axis of the second birefringent layer 14 may be substantially perpendicular to the longitudinal direction of the film (absorption axis of the polarizer 11).

Finally, as shown in FIG. 6B, the substrate 26 is peeled off, to thereby provide the elliptically polarizing plate 10 of the present invention.

Another further example of the specific procedure for the production method of the present invention will be described.

As described above and shown in the perspective view of FIG. 3, the continuous polarizer 11 is produced.

Next, as shown in the schematic diagram of FIG. 7, the second transparent protective film (eventually, the second protective layer) 15, the polarizer 11, and the transparent protective film (eventually, the protective layer) 12 are delivered in a direction of an arrow, and are attached together by using an adhesive or the like (not shown) with the respective longitudinal directions in the same direction. As a result, a laminate 126 of second protective layer (transparent protective film) 15/polarizer 11/protective layer (transparent protective film) 12 can be obtained.

Next, as described above, a surface (side opposite to the polarizer 11) of the transparent protective film 12 is subjected to rubbing treatment by using a rubbing roll (now shown). At this time, the rubbing direction is in a direction different from the longitudinal direction of the transparent protective film 12 such as +23° to +24° or −23° to −24°.

Then, the first birefringent layer 13 is formed (not shown) on the surface of the protective layer (transparent protective film) 12 subjected to the rubbing treatment as described in the above sections B-2 and B-3. The first birefringent layer 13 has a liquid crystal material aligned along the rubbing direction, and the direction of its slow axis is in substantially the same direction as the rubbing direction of the protective layer (transparent protective film) 12. As a result, a laminate 123 of second protective layer (transparent protective film) 15/polarizer 11/protective layer (transparent protective film) 12/first birefringent layer 13 can be obtained.

As shown in the schematic diagram of FIG. 6A, a continuous laminate 125 (having the second birefringent layer 14 supported on a substrate 26) is prepared. The laminate and a laminate 123 (of the second protective layer (transparent protective film) 15, the polarizer 11, the protective layer (transparent protective film) 12, and the first birefringent layer 13) are delivered in a direction of an arrow, and are attached together by using an adhesive or the like (not shown) with the respective longitudinal directions in the same direction. As described above, when the direction (angle α) of the slow axis of the first birefringent layer 13 is set to +23′ to +24° or −23′ to −24′ with respect to the longitudinal direction of the film (absorption axis of the polarizer 11), the slow axis of the second birefringent layer 14 may be substantially perpendicular to the longitudinal direction of the film (absorption axis of the polarizer 11).

Finally, as shown in FIG. 6B, the substrate 26 is peeled off, to thereby provide the elliptically polarizing plate 10 of the present invention.

B-7. Other Components of Elliptically Polarizing Plate

The elliptically polarizing plate of the present invention may further include another optical layer. Any suitable optical layers may be employed as the other optical layer in accordance with the purpose or the type of image display apparatus. Specific examples of the other optical layer include a birefringent layer (retardation film), a liquid crystal film, a light scattering film, and a diffraction film.

The elliptically polarizing plate of the present invention may further include a sticking layer as an outermost layer on at least one side. Inclusion of the sticking layer as an outermost layer facilitates lamination of the elliptically polarizing plate with other members (such as liquid crystal cell), to thereby prevent peeling off of the elliptically polarizing plate from other members. Any suitable materials may be employed as a material for the sticking layer. Specific examples of the material include those described in the section B-4. A material having excellent humidity resistance and thermal resistance is preferably used in view of preventing foaming or peeling due to moisture absorption, degradation of optical characteristics and warping of a liquid crystal cell due to difference in thermal expansion, and the like.

For practical purposes, the surface of the sticking layer is covered with an appropriate separator until the elliptically polarizing plate is actually used, to thereby prevent contamination. The separator may be formed by providing a release coating on any suitable film by using a silicone-based, long-chain alkyl-based, fluorine-based, or molybdenum sulfide release agent, for example.

Each layer of the elliptically polarizing plate of the present invention may be provided with UV absorbability through treatment or the like with a UV absorber such as a salicylate-based compound, a benzophenone-based compound, a benzotriazole-based compound, a cyanoacrylate-based compound, or a nickel complex salt-based compound.

C. Use of Elliptically Polarizing Plate

The elliptically polarizing plate of the present invention may be suitably used for various image display apparatuses (such as liquid crystal display and selfluminous display). Specific examples of the image display apparatus for which the elliptically polarizing plate may be used include a liquid crystal display, an EL display, a plasma display (PD), and a field emission display (FED). The elliptically polarizing plate of the present invention used for a liquid crystal display is useful for viewing angle compensation, for example. The elliptically polarizing plate of the present invention is used for a liquid crystal display of a circularly polarization mode, and is particularly useful for a homogeneous alignment TN liquid crystal display, an in-plane switching (IPS) liquid crystal display, and a vertical alignment (VA) liquid crystal display. The elliptically polarizing plate of the present invention used for an EL display is useful for prevention of electrode reflection, for example.

D. Image Display Apparatus

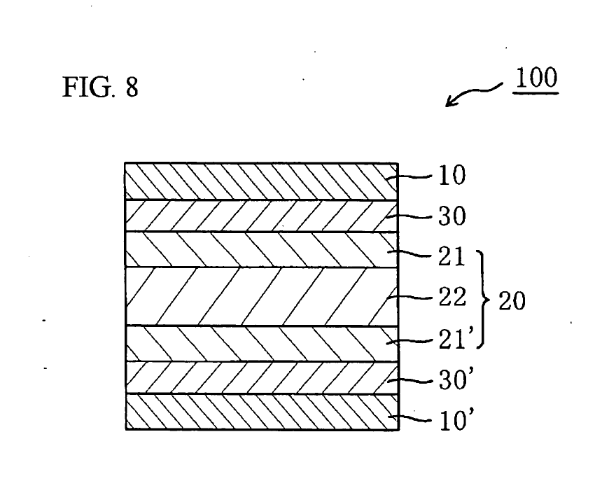

A liquid crystal display apparatus will be described as an example of an image display apparatus of the present invention. Here, a liquid crystal panel used for the liquid crystal display apparatus will be described. Any suitable constitutions may be employed for a constitution of the liquid crystal display apparatus excluding the liquid crystal panel in accordance with the purpose. FIG. 8 is a schematic sectional view of a liquid crystal panel according to a preferred embodiment of the present invention. A liquid crystal panel 100 includes: a liquid crystal cell 20, retardation plates 30 and 30′ arranged on both sides of the liquid crystal cell 20; and polarizing plates 10 and 10′ arranged on outer sides of the respective retardation plates. Any suitable retardation plates may be employed as the retardation plates 30 and 30′ in accordance with the purpose and an alignment mode of the liquid crystal cell. At least one of the retardation plates 30 and 30′ may be omitted in accordance with the purpose and the alignment mode of the liquid crystal cell. The polarizing plate 10 employs the elliptically polarizing plate of the present invention as described in the sections A and B. The polarizing plate (elliptically polarizing plate) 10 is arranged such that the birefringent layers 13 and 14 are positioned between the polarizer 11 and the liquid crystal cell 20. The polarizing plate 10′ employs any suitable polarizing plates (preferably, the polarizing plate 10′ employs the elliptically polarizing plate of the present invention as described in the sections A and B). The polarizing plates 10 and 10′ are generally arranged such that absorption axes of the respective polarizers are perpendicular to each other. As shown in FIG. 8, the elliptically polarizing plate 10 of the present invention is preferably arranged on a viewer side (upper side) in the liquid crystal display apparatus (liquid crystal panel) of the present invention. The liquid crystal cell 20 includes: a pair of glass substrates 21 and 21′; and a liquid crystal layer 22 as a display medium arranged between the substrates. One substrate (active matrix substrate) 21′ is provided with: a switching element (TFT, in general) for controlling electrooptic characteristics of liquid crystal; and a scanning line for providing a gate signal to the switching element and a signal line for providing a source signal thereto (the element and the lines not shown). The other glass substrate (color filter substrate) 21 is provided with color filters (not shown). The color filters may be provided in the active matrix substrate 211 as well. A space (cell gap) between the substrates 21 and 21′ is controlled by a spacer (not shown). An alignment layer (not shown) formed of, for example, polyimide is provided on a side of each of the substrates 21 and 21′ in contact with the liquid crystal layer 22.

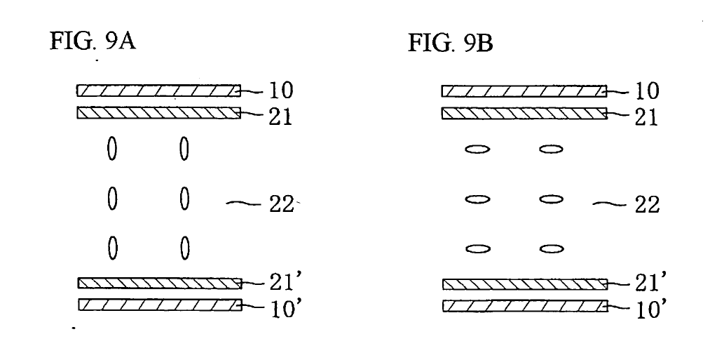

For example, a display mechanism of VA mode will be described. FIGS. 9A and 9B are each a schematic sectional view explaining an alignment state of liquid crystal molecules in VA mode. As shown in FIG. 9A, the liquid crystal molecules are aligned vertically to surfaces of the substrates 21 and 21′ under no voltage application. Such vertical alignment may be realized by arranging nematic liquid crystals having negative dielectric anisotropy between substrates each having formed thereon a vertically aligned film (not shown). Linear polarized light allowed to pass through the polarizing plate 10′ in such a state enters the liquid crystal layer 22 from a surface of one substrate 21′, and advances along long axes of vertically aligned liquid crystal molecules. No birefringence generates in a long axis direction of the liquid crystal molecules such that incident light advances without changing a polarization direction and is absorbed by the polarizing plate 10 having a polarization axis perpendicular to the polarizing plate 10′. In this way, dark display is obtained under no voltage application (normally black mode). As shown in FIG. 9B, the long axes of the liquid crystal molecules align parallel to the surfaces of the substrates under voltage application between electrodes. The liquid crystal molecules exhibit birefringence with respect to linear polarized light entering the liquid crystal layer 22 in such a state, and a polarization state of incident light varies depending on inclination of the liquid crystal molecules. Light allowed to pass through the liquid crystal layer 22 under application of a predetermined maximum voltage rotates its polarization direction by 90°, for example, into linear polarized light and passes through the polarizing plate 10, to thereby provide light display. Return to a state under no voltage application provides dark display again by alignment control force. The inclination of the liquid crystal molecules may be controlled by varying an application voltage to change an intensity of transmitted light from the polarizing plate 10, to thereby provide gradient display.

Hereinafter, the present invention will be more specifically described by way of examples. However, the present invention is not limited to the examples. Methods of measuring characteristics in the examples are as described below.

(1) Measurement of Retardation

Refractive indices nx, ny, and nz of a sample film were measured with an automatic birefringence analyzer (Automatic birefringence analyzer KOBRA-31PR manufactured by Oji Scientific Instruments), and an in-plane retardation Δnd a thickness direction retardation Rth were calculated. A measurement temperature was 23° C., and a measurement wavelength was 590 nm.

(2) Measurement of Thickness

The thickness of each of the first and second birefringent layers was measured through interference thickness measurement by using MCPD-2000, manufactured by Otsuka Electronics Co., Ltd. The thickness of each of other various films was measured with a dial gauge.

(3) Measurement of Transmittance

The same elliptically polarizing plates obtained in Example 1 were attached together. The transmittance of the attached sample was measured with DOT-3 (trade name, manufactured by Murakami Color Research Laboratory).

(4) Measurement of Contrast Ratio

The same elliptically polarizing plates were superimposed, and were irradiated with backlight. A white image (absorption axes of polarizers are in parallel with each other) and a black image (absorption axes of polarizers are perpendicular to each other) were displayed, and were scanned from 45° to 135° with respect to the absorption axis of the polarizer on the visual side, and from −60° to 60° with respect to the normal by using “EZ Contrast 160D” (trade name, manufactured by ELDIM SA). A contrast ratio “YW/YB” in an oblique direction was calculated from a Y value (YW) of the white image and a Y value (YB) of the black image.

### EXAMPLE 1

I. Alignment Treatment for Transparent Protective Film (Preparation of Aligned Substrate)

Transparent protective films were subjected to alignment treatment, to thereby prepare aligned substrates (eventually, protective layers 12).

Substrates (1) to (8): A PVA film (thickness of 0.1 μm) was formed on a surface of a TAC film (thickness of 40 μm) Then, the surface of the PVA film was subjected to rubbing at a rubbing angle shown in the following table by using a rubbing cloth, to thereby form each of aligned substrates.

Substrates (9) and (10): A TAC film (thickness of 40 μm) was subjected to rubbing at a rubbing angle shown in the following table by using a rubbing cloth, to thereby form each of aligned substrates.

Substrates (11) and (12): A silane coupling agent (KBM-503, trade name; available from Shin-Etsu Silicones) was applied onto a surface of a TAC film (thickness of 40 μm). The surface of the TAC film was subjected to rubbing at a rubbing angle shown in the following table by using a rubbing cloth, to thereby form each of aligned substrates.

Substrates (13) and (14): A PVA film (thickness of 0.1 μm) was formed on a surface of a TAC film (thickness of 40 μm). Then, the surface of the PVA film was subjected to rubbing at a rubbing angle shown in the following table by using a rubbing cloth, to thereby form each of aligned substrates. Table 1 collectively shows the rubbing angle and thickness direction retardation of each of the protective layers.

TABLE 1

| | | | Thickness |
|---|---|---|---|
| | | Rubbing angle | direction |
| No. | Substrate | (angle α) | retardation |
| (1) | TAC + PVA | 8° | 61 nm |
| (2) | TAC + PVA | −8° | 61 nm |
| (3) | TAC + PVA | 13° | 61 nm |
| (4) | TAC + PVA | −13° | 61 nm |
| (5) | TAC + PVA | 23° | 61 nm |
| (6) | TAC + PVA | −23° | 59 nm |
| (7) | TAC + PVA | 33° | 61 nm |
| (8) | TAC + PVA | −33° | 61 nm |
| (9) | TAC | −23° | 59 nm |
| (10) | TAC | −33° | 61 nm |
| (11) | TAC + Si | 23° | 61 nm |
| (12) | TAC + Si | −23° | 59 nm |
| (13) | TAC + PVA | 38° | 61 nm |
| (14) | TAC + PVA | −38° | 61 nm |

II. Production of First Birefringent Layer

10 g of polymerizable liquid crystal (liquid crystal monomer) (Paliocolor LC242, trade name; available from BASF Aktiengesellschaft) exhibiting a nematic liquid crystal phase, and 3 g of a photopolymerization initiator (IRGACURE 907, trade name; available from Ciba Specialty Chemicals) for the polymerizable liquid crystal compound were dissolved in 40 g of toluene, to thereby prepare a liquid crystal application liquid. The liquid crystal application liquid was applied onto the aligned substrate prepared as described above by using a bar coater, and the whole was heated and dried at 90° C. for 2 minutes, to thereby align the liquid crystal. The thus-formed liquid crystal layer was irradiated with light of 1 mJ/cm² by using a metal halide lamp, and the polymerizable liquid crystal of the liquid crystal was polymerized so that the alignment of the liquid crystal layer was fixed, to thereby form each of first birefringent layers (1) to (3). The thickness and retardation of each of the first birefringent layers were adjusted by changing an application amount of the liquid crystal application liquid. The following table shows the thickness and in-plane retardation value (nm) of each of the first birefringent layers formed.

TABLE 2
First birefringent layer

| | | |
|---|---|---|
| No. | Thickness | Retardation |

| | | | | |
|---|---|---|---|---|
| (1) | 2.2 | μm | 180 | nm |
| (2) | 2.4 | μm | 240 | nm |
| (3) | 2.6 | μm | 300 | nm |

III. Production of Second Birefringent Layer
III-a. Preparation of Substrate

A polyethylene terephthalate roll (width of 4 m) having an alignment axis in a width direction and having a variation in alignment axis of ±1° or less with respect to an average direction of alignment axes was prepared.

III-b. Formation of Second Birefringent Layer

Second birefringent layers (21) to (23) were formed in the same manner as in the section II. The thickness and retardation of each of the second birefringent layers were adjusted by changing the application amount of the liquid crystal application liquid. The following table shows the thickness and in-plane retardation value (nm) of each of the second birefringent layers formed.

TABLE 3
Second birefringent layer

| | | |
|---|---|---|
| No. | Thickness | Retardation |

| | | | | |
|---|---|---|---|---|
| (21) | 1.1 | μm | 90 | nm |
| (22) | 1.2 | μm | 120 | nm |
| (23) | 1.3 | μm | 150 | nm |

IV. Production of Elliptically Polarizing Plate

A polyvinyl alcohol film was colored in an aqueous solution containing iodine and was then uniaxially stretched to 6 times length between rolls of different speed ratios in an aqueous solution containing boric acid, to thereby obtain a polarizer. The protective layer, the first birefringent layer, and the second birefringent layer were used in the combination shown in the following table. The polarizer, the protective layer, the first birefringent layer, and the second birefringent layer were laminated through the production procedure shown in FIGS. 3 to 7, to thereby obtain each of elliptically polarizing plates A01 to A18 as shown in FIG. 1.

TABLE 4

| | | First | Second | | |
|---|---|---|---|---|---|
| | | birefringent | birefringent | | |
| Elliptically | Protective | layer | layer | | Entire |
| polarizing | layer | (in-plane | (direction of | Transmittance | thickness |
| plate | (angle α) | retardation) | slow axis) | (%) | (μm) |
| A01 | 5 (+23°) | 1 (180 nm) | 22 (120 nm) | 0.10 | 116 |
| A02 | 6 (−23°) | 1 (180 nm) | 22 (120 nm) | 0.10 | 116 |
| A03 | 5 (+23°) | 2 (240 nm) | 22 (120 nm) | 0.05 | 116 |
| A04 | 6 (−23°) | 2 (240 nm) | 22 (120 nm) | 0.05 | 116 |
| A05 | 5 (+23°) | 3 (300 nm) | 22 (120 nm) | 0.08 | 117 |
| A06 | 6 (−23°) | 3 (300 nm) | 22 (120 nm) | 0.08 | 117 |
| A07 | 5 (+23°) | 2 (240 nm) | 21 (90 nm) | 0.09 | 116 |
| A08 | 6 (−23°) | 2 (240 nm) | 21 (90 nm) | 0.09 | 116 |
| A09 | 5 (+23°) | 2 (240 nm) | 23 (150 nm) | 0.10 | 116 |
| A10 | 6 (−23°) | 2 (240 nm) | 23 (150 nm) | 0.10 | 116 |
| A11 | 3 (+13°) | 2 (240 nm) | 22 (120 nm) | 0.13 | 116 |
| A12 | 4 (−13°) | 2 (240 nm) | 22 (120 nm) | 0.13 | 116 |
| A13 | 7 (+33°) | 2 (240 nm) | 22 (120 nm) | 0.14 | 116 |
| A14 | 8 (−33°) | 2 (240 nm) | 22 (120 nm) | 0.14 | 116 |
| A15 | 9 (−23°) | 2 (240 nm) | 22 (120 nm) | 0.06 | 116 |
| A16 | 10 (−33°) | 2 (240 nm) | 22 (120 nm) | 0.06 | 116 |
| A17 | 11 (+23°) | 2 (240 nm) | 22 (120 nm) | 0.07 | 116 |
| A18 | 12 (−23°) | 2 (240 nm) | 22 (120 nm) | 0.07 | 116 |

### EXAMPLE 2

The elliptically polarizing plates A03 were superimposed to measure a contrast ratio. The elliptically polarizing plate had the minimum angle of 40° and maximum angle of 50° for contrast 10 in all directions, and a difference between the maximum and minimum angles of 10°. The minimum angle of 40° for contrast 10 in all directions was at a preferable level in practical use. Further, the difference between the maximum and minimum angles was as small as 10° and was also at a very preferable level in practical use, and thus the elliptically polarizing plate had balanced visual characteristics.

### EXAMPLE 3

The elliptically polarizing plates A09 were superimposed to measure a contrast ratio. The elliptically polarizing plate had the minimum angle of 40° and maximum angle of 60° for contrast 10 in all directions, and a difference between the maximum and minimum angles of 20°. The minimum angle of 40° for contrast 10 in all directions was at a preferable level in practical use.

### INDUSTRIAL APPLICABILITY

The elliptically polarizing plate of the present invention may suitably be used for various image display apparatuses (such as a liquid crystal display apparatus and a self-luminous display apparatus).

1. An elliptically polarizing plate comprising a polarizer, a protective layer formed on one side of the polarizer, a first birefringent layer serving as a λ/2 plate, and a second birefringent layer serving as a λ/4 plate in the order given, wherein
the first birefringent layer and the second birefringent layer are each formed by using a liquid crystal material.

2. An elliptically polarizing plate according to claim 1, wherein the first birefringent layer has a thickness of 0.5 to 5 μm.

3. An elliptically polarizing plate according to claim 1, wherein the second birefringent layer has a thickness of 0.3 to 3 μm.

4. An elliptically polarizing plate according to claim 1, wherein a slow axis of the first birefringent layer is defined at one angle of +8° to +38° and −8° to −38° with respect to an absorption axis of the polarizer.

5. An elliptically polarizing plate according to claim 1, wherein the absorption axis of the polarizer and a slow axis of the second birefringent layer are substantially perpendicular to each other.

6. A method of producing an elliptically polarizing plate comprising the steps of:
subjecting a surface of a transparent protective film (T) to alignment treatment;
forming a first birefringent layer on the surface of the transparent protective film (T) subjected to the alignment treatment;
laminating a polarizer on a surface of the transparent protective film (T); and
laminating a second birefringent layer on a surface of the first birefringent layer, wherein
the polarizer and the first birefringent layer are arranged on opposite sides of the transparent protective film (T).

7. A method of producing an elliptically polarizing plate according to claim 6, wherein: the transparent protective film (T), the first birefringent layer, the polarizer, and the second birefringent layer comprise continuous films; and long sides of the transparent protective film (T), the first birefringent layer, the polarizer, and the second birefringent layer are attached together for lamination.

8. A method of producing an elliptically polarizing plate according to claim 6, wherein the step of forming a first birefringent layer comprises the steps of: applying an application liquid containing a liquid crystal material; and aligning the applied liquid crystal material through treatment at a temperature at which the liquid crystal material exhibits a liquid crystal phase.

9. A method of producing an elliptically polarizing plate according to claim 8, wherein: the liquid crystal material comprises at least one of a polymerizable monomer and a crosslinking monomer; and the step of aligning the liquid crystal material further comprises the step of performing at least one of polymerization treatment and crosslinking treatment.

10. A method of producing an elliptically polarizing plate according to claim 9, wherein at least one of the polymerization treatment and the crosslinking treatment is performed by one of heating and photoirradiation.

11. A method of producing an elliptically polarizing plate according to claim 6, wherein the step of laminating a second birefringent layer comprises the steps of: applying an application liquid containing a liquid crystal material to a substrate; forming a second birefringent layer on the substrate by subjecting the applied liquid crystal material to treatment at a temperature at which the liquid crystal material exhibits a liquid crystal phase; and transferring the second birefringent layer formed on the substrate to the surface of the first birefringent layer.

12. A method of producing an elliptically polarizing plate according to claim 11, wherein the substrate comprises a continuous film having an alignment axis in its width direction.

13. A method of producing an elliptically polarizing plate according to claim 11, wherein a variation in alignment axis of the substrate is ±1° or less with respect to an average direction of the alignment axes.

14. A method of producing an elliptically polarizing plate according to claim 11, wherein the substrate comprises a polyethylene terephthalate film obtained through stretching treatment and recrystallization treatment.

15. A method of producing an elliptically polarizing plate according to claim 11, wherein the substrate is used for the step of applying an application liquid without being subjected to alignment treatment on its surface.

16. An image display apparatus comprising the elliptically polarizing plate according to claim 1.
